(19) United States
(12) Patent Application Publication
(10) Pub. No.: US 2012/0238428 A1
(43) Pub. Date: Sep. 20, 2012

(54) METHOD FOR PROVIDING A WOUND UP FIBER REINFORCED TUBE

(75) Inventors: Lambertus Gerrit Peter DALMOLEN, Zaandam (NL); David Brent SUMMERS, Rogers, AR (US)

(73) Assignee: PIPELIFE NEDERLAND B.V., Enkhuizen (NL)

(21) Appl. No.: 13/051,138

(22) Filed: Mar. 18, 2011

(51) Int. Cl. B31C 1/00

(52) U.S. Cl. 493/299

(57) ABSTRACT

A method for providing a wound up fiber reinforced tube includes the steps of:
manufacturing a fiber reinforced tube by:
   providing a plastic inner liner (1),
   subsequently providing a reinforcement layer (2) around the liner,
   subsequently providing a coating layer (3) around the reinforcement layer,
winding the manufactured fiber reinforced tube onto a reel,
   characterized by
providing a shear connection element (4) between the liner (1) and the reinforcement layer (2).

### BACKGROUND OF THE INVENTION

The invention is related to the field of producing fiber reinforced tubes. Depending on the nature of the fibers applied, such tubes usually have a high strength. For instance, fibers with high strength and high stiffness such as aramid fibers make the tubes in question suitable for the transport of high pressure liquids and gasses. Examples thereof are crude oil and natural gas, which may comprise aggressive components. Such components may be detrimental to steel pipes, for which reason it is desirable to use fiber reinforced tubes having a proper liner which can withstand the aggressive nature of such fluids.

The strength of the tube therefore depends heavily on the fiber reinforcement. As mentioned, the tubes comprise an inner liner so as to convey the fluids. Onto the liner, the fiber reinforcement layer is applied, and finally the coating layer is applied onto the fiber reinforcement layer. This fiber reinforcement layer may be carried out in various shapes. As an example, the fiber reinforcement layer may be a braided layer. Alternatively, the fibers may be embedded in a tape which is wound around the liner according to a helical shape. Also, the fibers may be wound onto the liner according to various plies and winding angles.

Although the several layers of a fiber reinforced tube may all consist of a plastic material, often these materials differ greatly from each other as a result of the different functions thereof. This results in a tube the layers of which have no or only a poor interconnection or coherence. In practical applications of the tube, this does not lead to problems. However, it appears that handling of the tube before this is laid in the field is problematic, in particular in case the liner of the tube has a relatively small wall thickness.

It appears that in the process of winding the tube onto a reel for further transport thereof, problems and even damages may occur. For the purpose of transport by truck or train, the tube has to be wound up according to a relatively small diameter onto a reel as otherwise the wound tube will be too bulky for road transport etc. As a result of the winding action, the several layers of the tube are brought into a curved shape. Generally, the several layers are able to cope with a certain curved shape by deforming in an elastic manner, which means that the tube may regain its original elongated shape upon unwinding from the reel. The ability of a specific layer to regain its original shape is largely dependent on the thickness thereof in relation to the radius of curvature of the wound tube. The inner layer, which by definition has the smallest radius of curvature, is in particular vulnerable and may give rise to problems. It appears that this layer may be unable to elastically adapt to the curvature which results from the winding action, and becomes unstable when winding the tube according to a relatively small winding radius. This may result in the liner wall exhibiting buckling phenomena.

The buckling of the inner layer however will generally lead to plastic deformation, for which reason said layer is no longer able to completely return to the undisturbed longitudinal shape upon unwinding. This is of course highly undesirable, as a tube having such grave imperfections will generally not be able to withstand the relatively high pressures for which it was originally designed. Moreover, a buckled or otherwise deformed liner will impair the flow characteristic and the flow capacity of the tube. A remedy to circumvent this problem is to increase the wall thickness of the liner, which however goes at the expense of the flow capacity as well, for a given outer diameter of the tube.

### BRIEF SUMMARY OF THE INVENTION

The object of the invention is therefore to provide a solution to this problem, and to provide a method which enables a fiber reinforced tube to be wound up in such a manner that the several layers thereof are deformed only elastically and are thus able to regain their nominal shape upon unwinding the tube. This object is achieved through a method for providing a wound up fiber reinforced tube, comprising the steps of:
manufacturing a fiber reinforced tube by:
   providing a plastic inner liner,
   subsequently providing a reinforcement layer around the liner,
   subsequently providing a coating layer around the reinforcement layer,
winding the manufactured fiber reinforced tube onto a reel, characterized by
providing a shear connection means between the liner and the reinforcement layer.

According to the invention, a fiber reinforced tube is manufactured in a generally known way, however the additional step of providing a shear connection means between the liner and the reinforcement layer makes that said components are unified with respect to bending deformations. This provides the advantage that the unified structure has a greater resistance against buckling, in particular when subjected to the deformations which occur as a result of winding the tube onto a reel. After all, the buckling resistance of an assembly of the liner and the reinforcement layer is both dependent on the outer diameter thereof as well on the assembled wall thickness. These dimensions are both larger than for the liner in isolation, leading to a relatively high buckling resistance in comparison to the buckling resistance of the liner per se. Thus, despite the low resistance of a relatively thin liner itself, the tube can be wound up according to a relatively small roll diameter without buckling of the liner taking place.

The method according to the invention can be carried out in several ways.

According to a first possibility, it may comprise the steps of:
providing the shear connection means on the liner,
subsequently providing the reinforcement layer.
   According to a second possibility, the method according to the invention may comprise the step of:
simultaneously providing the shear connection means and the reinforcement layer on the liner.

The shear connection means may take several forms, and may for instance contain a layer of glue. Preference is given to the embodiment using a double sided adhesive tape as shear connection means.

According to the invention, the step of winding said tube onto a reel is carried out immediately or directly after completion of the manufacturing of the fiber reinforced tube. Thus, the effect of the shear connection means in principle need only be present at that point in time. Subsequently, once the tube has been wound onto the reel, the effect of the shear connection means is no longer necessary and may diminish or may even cease to exist. The method according to the invention therefore preferably also comprises the steps of:
establishing a useful lifetime if the fiber reinforced tube,
making the effect of the shear connection last for at most a fraction of the useful lifetime of the tube.

Also or alternatively, the method according to the invention may comprise the steps of:
making the effect of the shear connection last for a time span which is at most of the same order of magnitude as the time span within which the winding operation for winding the tube onto the reel is carried out.

The reinforcement layer may be applied in several ways, such as by the step of helically winding a tape with reinforcement threads around the liner. Preferably, the reinforcement layer is obtained by braiding a sleeve around the liner. Furthermore, a synthetic fiber, such as polyester fiber, may be used for providing the reinforcement layer. The coating layer may be obtained by extrusion of plastic material onto the braided reinforcement layer.

In particular, the materials of the liner and of the reinforcement layer may be incompatible as to adhesion or fusion. For instance, the liner may comprise (high density) polyethylene (HDPE), polyamides like polyamide 11 or polyamide 12, polyvinylidenedifluoride (PVDF), polypropylene (PP) or other thermoplastic resin. The reinforcement layer may comprise polyethyleneterephtalate fiber (PET fiber), aromatic polyamide fiber (aramid fiber), carbon fiber, glass fiber and other high strength synthetic fiber.

The invention is furthermore related to, in combination, a reel and a fiber reinforced tube manufactured according to the method of any of the preceding claims wound up onto the reel.

### BRIEF DESCRIPTION OF THE SEVERAL VIEWS OF THE DRAWINGS

The invention will now be described further with reference to the drawings.

FIG. 1 shows a view in perspective of the tube, with part of the layers removed.

FIG. 2 shows a longitudinal section of the tube.

### DETAILED DESCRIPTION OF THE INVENTION

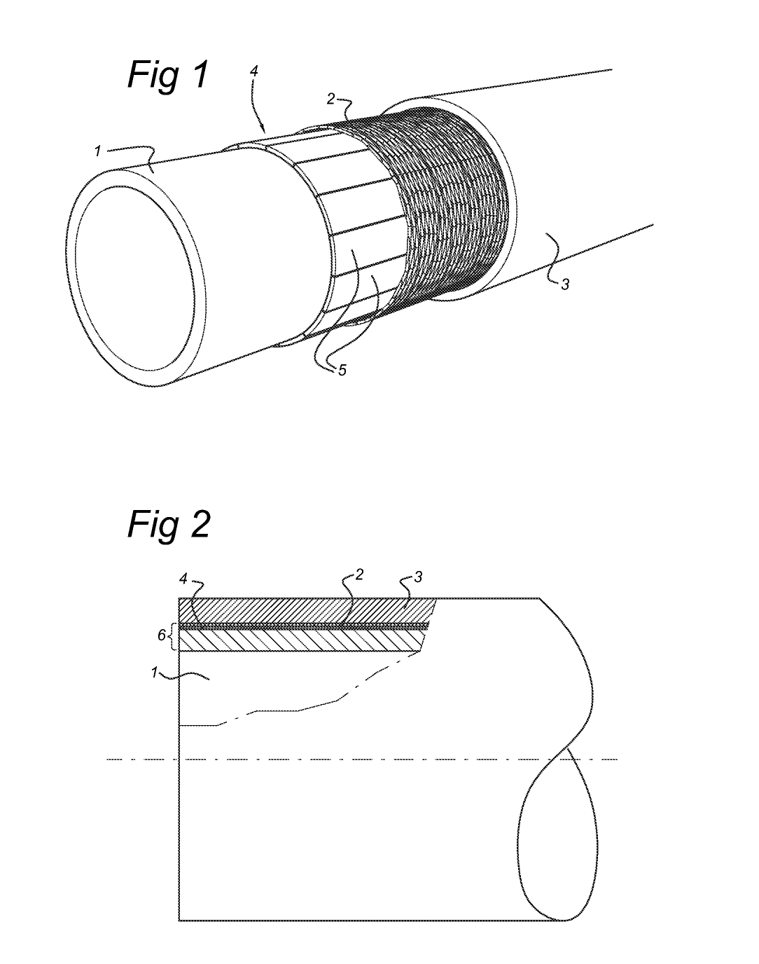

The tube as shown in FIGS. 1 and 2 consists of a liner 1 with a nominal inner diameter which defines the flow capacity of the tube. The liner is of a material which is selected on the basis of the fluid to be transported, and in any case should be chemically inert with respect to such fluid. Around the liner, the reinforcement layer 2 has been applied. The purpose of this reinforcement layer is to provide resistance against the pressure of the fluids within the liner. For instance, the pressure of the fluid transported may be in the order of magnitude of several 100 bar, as is the case in certain applications in the field of hydrocarbon transport, e.g. crude oil and natural gas. As usual, a coating layer covers the reinforcement layer 2. The purpose of this coating layer is to protect the reinforcement layer against mechanical influences, weathering etc.

Due to the fact that the several layers, in particular the liner and the reinforcement layer, serve completely different purposes, the materials used for these layers are different as well. As a result, the layers in question do not adhere to each other as the materials thereof are usually chemically incompatible. Thus, the liner is able to settle somewhat with respect to the reinforcement layer. In fact, the behavior of the layers under bending deformations of the tube could be regarded as being independent from each other. This phenomenon plays an important role upon bending the tube, such as occurs while winding the tube onto a reel.

At the instance of such bending deformation of the tube, the liner behaves quasi as a single layer. The liner however has a relatively small wall thickness, due to the fact that its only purpose is to contain the fluids and that it does not take part in carrying the pressure of the fluid. These factors lead to the circumstance that the liner may easily buckle when the tube is subjected to bending. Buckling however may plastically deform the liner, in such a way that the unwound tube has a damaged or permanently deformed liner. This is highly undesirable, as the flow capacity of the tube is thereby impaired. Also, the liner may be punctured by the buckling phenomenon, whereby the fluid may escape and attack the reinforcement layer. This would ultimately lead to complete failure of the tube.

With the aim of preventing the liner from becoming buckled in this way, a shear connection means 4 is interposed between the liner 1 and the reinforcement layer 2. This shear connection means, in the embodiment shown, consists of double side adhesive tapes 5 which extend in the longitudinal direction and which adjoin each other. It is however also possible to select alternative arrangements, such as tapes at some distance from each other, tapes which are helically wound around the liner etc. The tapes proved a shear connection between the liner and the reinforcement layer, in such a way that the liner 1 and the reinforcement layer 2 mechanically behave as a single assembly 6.

This assembly 6 has a relatively high resistance against buckling, which means that the tube may be wound up to a without damaging the liner. After the tube has been wound up, the interconnection between the liner and the reinforcement layer is less important. Also, after the tube has been unwound and laid, the adhesive tape is no longer useful. Thus, it is possible to apply a tape or other interconnection means between the liner and the reinforcement layer which loses its effectiveness after a short period of time.

The reinforcement layer may be a braided layer, which is applied as a socket or sleeve over the liner. Other types of reinforcement are possible as well, such as a tape comprising reinforcement threads which is wound helically around the liner.

1. Method for providing a wound up fiber reinforced tube, comprising the steps of:
manufacturing a fiber reinforced tube by:
providing a plastic inner liner (1),
subsequently providing a reinforcement layer (2) around the liner,
subsequently providing a coating layer (3) around the reinforcement layer,
winding the manufactured fiber reinforced tube onto a reel,
characterized by
providing a shear connection means (4) between the liner (1) and the reinforcement layer (2).

2. Method according to claim 1, comprising the steps of:
providing the shear connection means (4) on the liner (1),
subsequently providing the reinforcement layer (2).

3. Method according to claim 1, comprising the step of:
simultaneously providing the shear connection means (4) and the reinforcement layer (2) on the liner (1).

4. Method according to claim 1, comprising the step of;
using a double sided adhesive tape (5) as shear connection means.

5. Method according to claim 1, comprising the step of:
immediately or directly after completion of the manufacturing of the fiber reinforced tube winding said tube onto a reel.

6. Method according to claim 1, comprising the step of;
providing the reinforcement layer (2) by braiding a sleeve around the liner (1).

7. Method according to claim 1, comprising the step of:
using a synthetic fiber, such as polyester fiber, for providing the reinforcement layer.

8. Method according to claim 1, comprising the step of:
providing the coating layer (3) by extrusion thereof onto the reinforcement layer (2).

9. Method according to claim 1, comprising the steps of:
establishing a useful lifetime if the fiber reinforced tube,
making the effect of the shear connection last for at most a fraction of the useful lifetime of the tube.

10. Method according to claim 1, comprising the steps of:
making the effect of the shear connection last for a time span which is at most of the same order of magnitude as the time span within which the winding operation for winding the tube onto the reel is carried out.

11. Method according to claim 1, comprising the step of:
selecting a plastic material for the fiber reinforcement layer and a plastic material for the liner which by their nature are incompatible as to adhesion or fusion.

12. Method according to claim 1, comprising the step of:
selecting (high density) polyethylene (HDPE), polyamides like polyamide 11 or polyamide 12, polyvinylidenedifluoride (PVDF), polypropylene (PP) or other thermoplastic resin as material for the liner (1),

13. Method according to claim 1, comprising the step of:
selecting polyethyleneterephtalate fiber (PET fiber), aromatic polyamide fiber (aramid fiber), carbon fiber, glass fiber and other high strength synthetic fiber as material for the reinforcement layer (2).

14. In combination, a reel and a fiber reinforced tube manufactured according to the method of claim 1 wound up onto the reel.
